(19) United States
(12) Patent Application Publication
(10) Pub. No.: US 2013/0094189 A1
(43) Pub. Date: Apr. 18, 2013

(54) Electroluminescent Light Assembly

(71) Applicant: Andrew Kimitri, Weston Super Mare (GB)

(72) Inventor: Andrew Kimitri, Weston Super Mare (GB)

(73) Assignee: FHOSS Technology Limited Weston-super-Mare, Somerset (GB)

(21) Appl. No.: 13/702,492

(22) PCT Filed: Jun. 8, 2010
(86) PCT No.: PCT/GB10/01122

§ 371 Date: Dec. 6, 2012

(51) Int. Cl. A41D 13/01; F21V 33/00; A41D 27/08; F21V 15/01

(52) U.S. Cl. CPC A41D 13/01; F21V 15/01; F21V 33/0008; A41D 27/08
USPC 362/108; 362/223; 362/157; 362/103; 29/428

(57) ABSTRACT

An electroluminescent light assembly (56, 58) and assembly method for providing an object (e.g. a garment) with safety lighting. An electroluminescent light source (10) is fabricated as a laminated structure insertable into a protective sheath (40, 51) formed on or secured to the object.

### FIELD OF THE INVENTION

The invention relates to high visibility equipment, e.g. for use as a safety measure in low light conditions.

BACKGROUND TO THE INVENTION

High visibility strips, e.g. retroreflective strips such as 3M's Scotchlite® material, are commonly used on clothing or other articles such as road traffic cones to provide high visibility in low light conditions. The strips operate to collect and reflect incident light with high efficiency (i.e. with minimal scattering), so that they stand out in an incident light beam.

High visibility garments are mandatory in certain industries. There are different standards of garments and colours required for different industries. For example, railway track workers are required to wear an orange vest with, a reflective strip over each shoulder and a reflective strip around the waist. The strips taper inwards as they extend from the shoulder to the middle of the body. In another example, road workers are required to wear a green vest with a reflective strip over each shoulder and two waist strips.

Typically a reflective strip is manufactured by affixing a retroreflective layer to a silver-coloured base strip. The base strip may be made from a material suitable for attaching to clothing. The strip may be attached, e.g. glued, sown in or the like, to a garment or other article.

Electroluminescent materials are materials (e.g. doped semiconductors) which emit light when an electric current (e.g. AC current having a frequency of 400 Hz or more) passes through the material due to radiative recombination of electrons and holes. The high visibility article may include a thin film (e.g. thickness less than 0.5 mm) electroluminescent material, e.g. a thin layer of light emitting phosphor such as ZnS:Cu or ZnS:Cu, Mg mounted between two electrodes. An advantage of such materials is that they may operate usefully with a low power supply, e.g. 12 V or 9 V battery supply. Electroluminescent materials may require less power than conventional lighting to achieve the same luminance. Moreover, the heat produced by the electroluminescent layer in use is minimal.

US 2006/0092625 discloses a tape-like structure having electroluminescent features for use in safety garments.

### SUMMARY OF THE INVENTION

At its most general, the present invention provides an electroluminescent light source and assembly method for providing an object (e.g. a garment) with safety lighting in which assembly is facilitated by fabricating an electroluminescent light source as a laminated structure insertable into a protective sheath formed on or secured to the object.

In one aspect, the invention may therefore provide an electroluminescent light assembly for an object, the assembly comprising: an electroluminescent light source comprising an elongate electroluminescent lamp laminated on a reflective base material; a protective sheath defining an elongate pocket for receiving the electroluminescent light source, the protective sheath having a transparent outward facing surface; wherein the width of the reflective base material is selected to match the width of the pocket to align the elongate electroluminescent lamp with the protective sheath.

The electroluminescent light source may be arranged to act as an independent light source, i.e. is not reliant on external energy (such as incident light on the high visibility article), for operation. For example, the electroluminescent light source may receive an energy input from an energy source contained in the object carrying the assembly. The energy input, e.g. electrical power from a battery, causes the electroluminescent light source to glow over an area, e.g. corresponding to the area of the protective sheath. The electroluminescent light source is substantially flat. In a preferred embodiment the outwardly facing surface of the sheath is a retroreflective layer arranged to reflect light incident thereon back towards its source.

The electroluminescent lamp may comprise one or more elongate elements arranged in series lengthwise within the sheath, but is preferably an unbroken length of material.

In another aspect, the invention may provide a method of applying an electroluminescent light assembly to an object, the method comprising: laminating an elongate electroluminescent lamp on to a reflective base material to form an electroluminescent light source; securing a protective sheath on the object, the protective sheath defining an elongate pocket for receiving the electroluminescent light source, the protective sheath having a transparent outward facing surface; matching the width of the reflective base material to the width of the pocket; and inserting the electroluminescent light source into the protective sheath.

Further aspects may include an anti-entanglement vest, a pair of trousers or a high visibility garment incorporating an electroluminescent light assembly according to the first aspect.

### BRIEF DESCRIPTION OF THE DRAWINGS

Embodiments of the inventions are described in detail below with reference to the accompanying drawings, in which:

FIGS. 1A and 1B are each a schematic views of an encapsulated electroluminescent strip suitable for use in an embodiment of the invention;

FIGS. 2A and 2B show the wired connection to the encapsulated electroluminescent strips shown in FIGS. 1A and 1B respectively;

FIGS. 3A and 3B show the sealed terminations of the encapsulated electroluminescent strips shown in FIGS. 1A and 1B respectively;

FIG. 4A is a schematic view of a clear tape sheath for containing an encapsulated electroluminescent strip, which is suitable for use in an embodiment of the invention;

FIG. 4B is a schematic view of a prismatic tape sheath for containing an encapsulated electroluminescent strip, which is suitable for use in an embodiment of the invention

FIGS. 4C and 4D are cross-sectional views through the sheaths of FIGS. 4A and 4B respectively;

FIG. 5A is a schematic view of the clear tape sheath of FIG. 4A with an encapsulated electroluminescent strip contained therein;

FIG. 5B is a schematic view of the clear tape sheath of FIG. 4B with an encapsulated electroluminescent strip contained therein;

FIGS. 5C and 5D are end views through the sheaths of FIGS. 5A and 5B respectively;

FIG. 6A is a schematic view of a pair of the clear tape sheaths of FIG. 4A connected to a power pack;

FIG. 6B is a schematic view of a pair of the clear tape sheaths of FIG. 4B connected to a power pack;

FIG. 7A shows a schematic view of the body part for an anti-entanglement vest that is an embodiment of the invention;

FIGS. 7B and 7C show the right and left wing parts for an anti-entanglement vest that is an embodiment of the invention;

FIG. 8 shows an anti-entanglement vest assembled from the parts of FIGS. 7A, 7B and 7C that is an embodiment of the invention;

FIG. 9 is a schematic view of the wire routing in the anti-entanglement vest shown in FIG. 8;

FIGS. 10A and 10B show front and back views respectively of the anti-entanglement vest of FIG. 8 in a zipped configuration;

FIGS. 11A and 11B shows front and back views respectively of a high-visibility jacket that is an embodiment of the invention;

FIGS. 12A and 12B shows front and side views respectively of a pair of high-visibility trousers that is an embodiment of the invention;

FIGS. 13A, 13B and 13C show various schematic views of the wire routing in the pair of high-visibility trousers shown in FIGS. 12A and 12B; and

FIGS. 14A, 14B and 14C show front and back views of a backpack harness that is another embodiment of the invention.

### DETAILED DESCRIPTION; FURTHER OPTIONS AND PREFERENCES

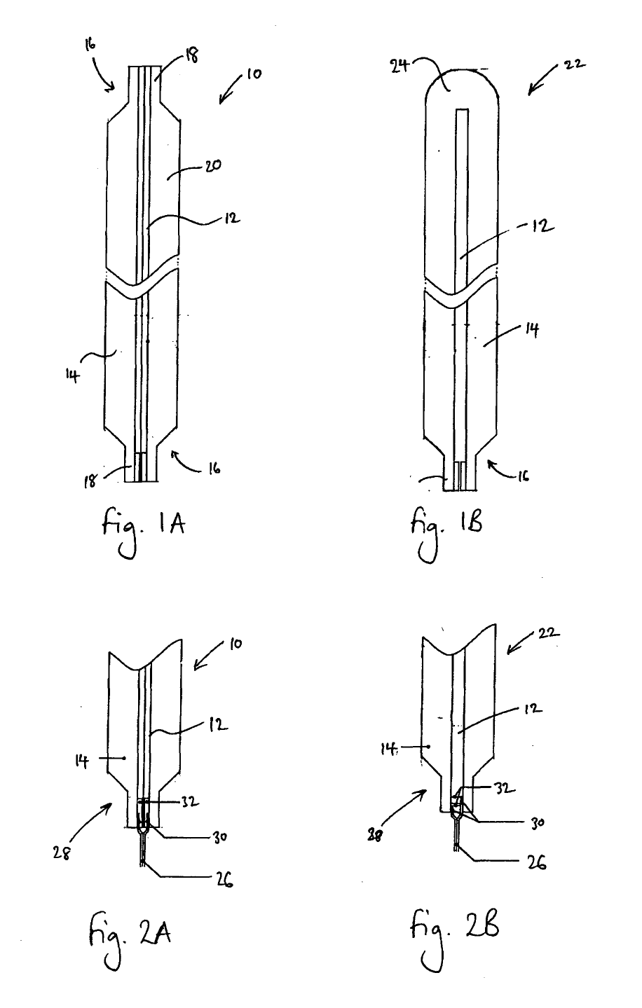

FIG. 1A shows a schematic view of a first example of an encapsulated electroluminescent light source 10 that is suitable for use in the present invention. The light source 10 comprises an electroluminescent lamp 12 (sometimes referred to as a light emitting capacitor) formed in a laminated structure with a reflective base material 14, e.g. Mylar® or the like. The electroluminescent lamp 12 may have a traditional parallel plate configuration. In a preferred embodiment, the electroluminescent lamp 12 is the FLATLITE® light source manufactured by E-Lite Technologies, Inc. The colour of the light emitted by the electroluminescent lamp 12 may be any of white, blue, red, yellow or green. The width of the lamp 12 may be from 2 mm or more.

The length of the electroluminescent lamp 12 and base material 14 is selected according to the intended use. An advantage of this arrangement is that the length is easily shortened, e.g. by cutting through the light source 10.

The width of the base material 14 is selected based on the size of the pocket in the sheath in which it is ultimately carried. The sheath is discussed in more detail below. Preferably the width of the base material 14 matches (i.e. is arranged to fit snugly within) the pocket of the sheath, so that the electroluminescent lamp 12 runs parallel to the sheath.

The base material. 14 at one or both ends 16 of the light source 10 may be trimmed to aid termination of the electroluminescent lamp 12. In FIG. 1A, the trimmed ends 16 each have a terminal portion 18 of reduced width, which tapers outwardly to a central portion 20 of the light source 10. Terminating the ends of the electroluminescent lamp 12 is discussed below with reference to FIGS. 3A and 3B.

FIG. 1B shows an alternative example of an electroluminescent light source 22 that is suitable for use in the invention. Features in FIG. 1B that are the same as FIG. 1A are given the same reference numbers. This example differs from FIG. 1A because the electroluminescent lamp 12 terminates before the end of the base material 14 at a non-connected end 24 of the light source 10. At the non-connected end, the base material is trimmed to a rounded configuration to facilitate insertion into the pocket of the sheath (discussed below).

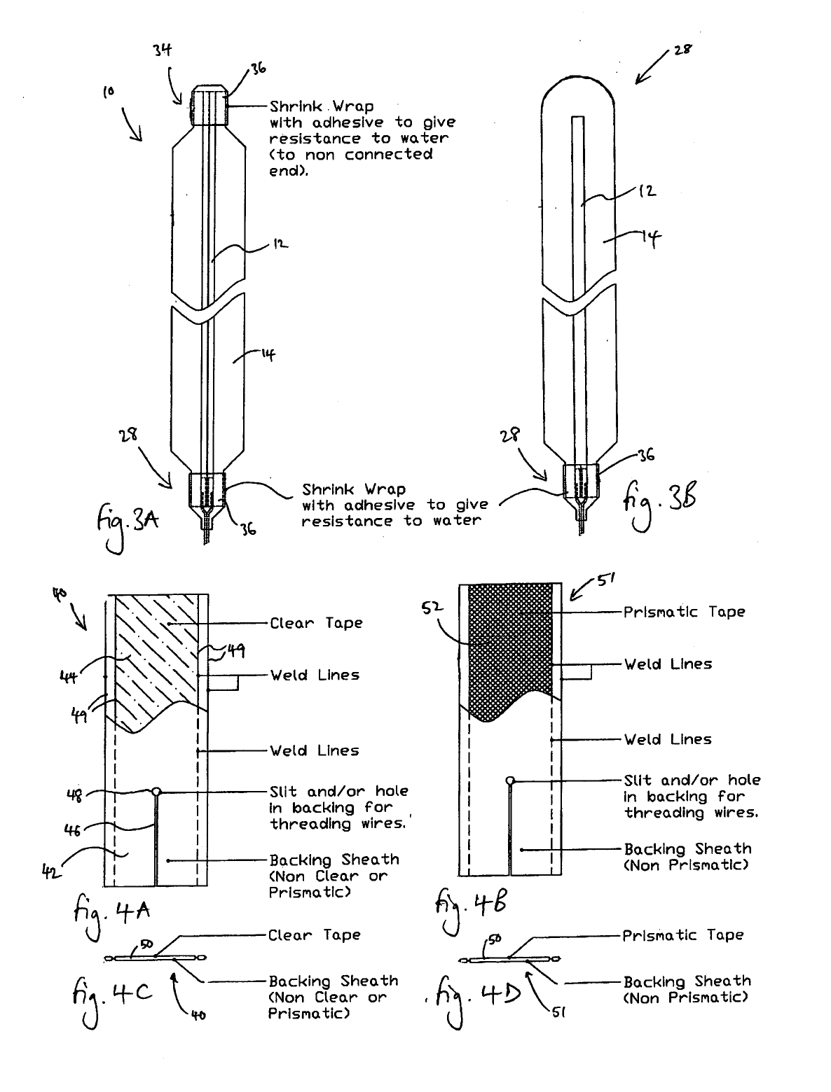

FIGS. 2A and 2B shows how electrical connection 26 is attached to the connected end 28 of the electroluminescent light sources 10, 22 shown in FIGS. 1A and 1B respectively. In each case, the electrical connection 26 comprises wiring having a pair of conductors, e.g. a coaxial cable, suitable for carrying an AC signal from a power source (not shown, but discussed below). Each conductor is connected to a respective electrode of the electroluminescent lamp 12. In the examples shown, each electrode of the electroluminescent lamp 12 has a conductive strip 32 (e.g. made from copper) adhered to it. Each conductor is attached to a respective conductive strip 32 by stapling or crimping 30. Where stapling is used, the wire may also be soldered to the conductive strip to ensure a good electrical connection.

FIGS. 3A and 3B depict how the exposed ends of the electroluminescent light sources of FIGS. 1A and 1B are sealed. In this example shown in FIG. 3A, a shrink wrap coating 36 is applied to both the connected end 28 and the non-connected end 34. An adhesive shrink wrap may be applied to give resistance to water.

In FIG. 3B, only the connected end 28 has a shrink wrap coating 36.

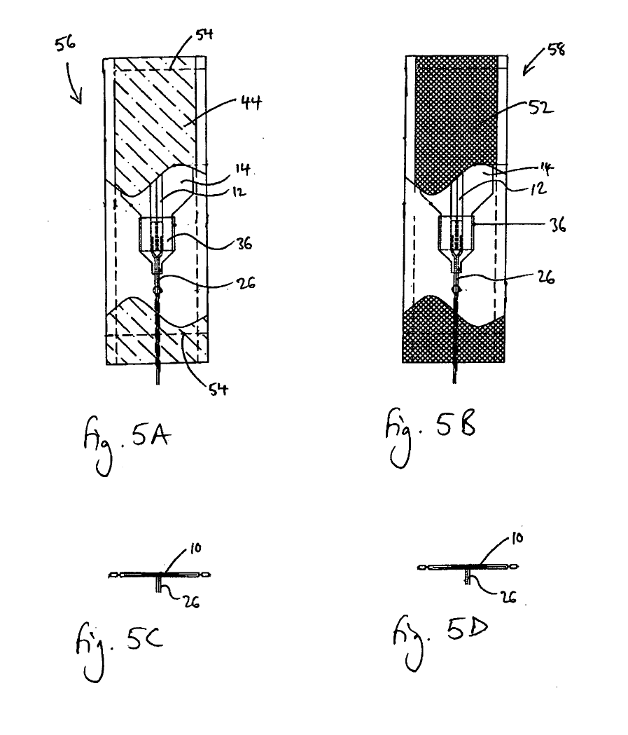

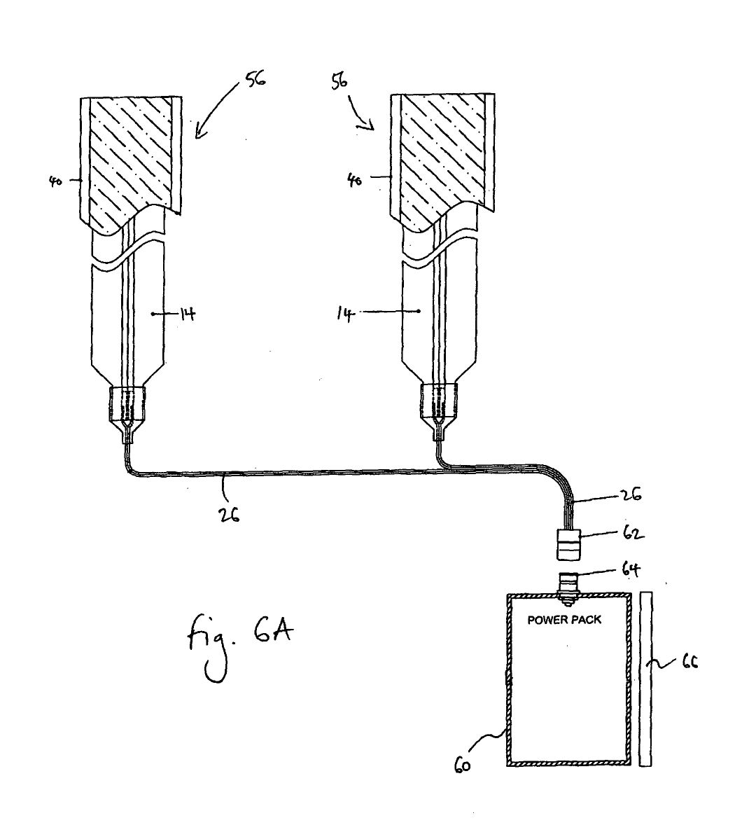

According to the present invention, the electroluminescent light source is mounted within a protective sheath, which in turn is secured to an object of interest (e.g. garment). FIGS. 4A and 4B shown two examples of a protective sheath that can be used in the invention.

FIG. 4A shows a first example of a protective sheath 40. The sheath 40 is formed from two strip-like layers which are overlaid and secured to one another along join lines which run parallel to each long edge. In this example, the strip-like layers comprise a backing layer 42 formed of non-transparent (preferably reflective) material and a front layer 44 (“clear tape”) formed of transparent material. The front layer 44 is shown partly cut away so that a slit 46 and wire feed hole 48 in the backing layer 42 can be seen. The join lines which secure the backing layer 42 to the front layer 44 are welds 49 (e.g. sonic welds) in this example. FIG. 4C shows a cross-sectional view of the sheath 40, where it can be seen that the backing layer 42 and front layer 44 form a pocket 50 therebetween for receiving the electroluminescent light source.

FIG. 4B shows a:sheath 51 that is similar to the sheath 40 shown in FIG. 4A, except that the front layer 52. (“prismatic layer”) is made from retroreflective material, e.g. from Reflexite Corporation). Other features shown in FIG. 4B are the same as shown in FIG. 4A. FIG. 4D shows a cross-sectional view of the sheath 51, again showing a pocket 50.

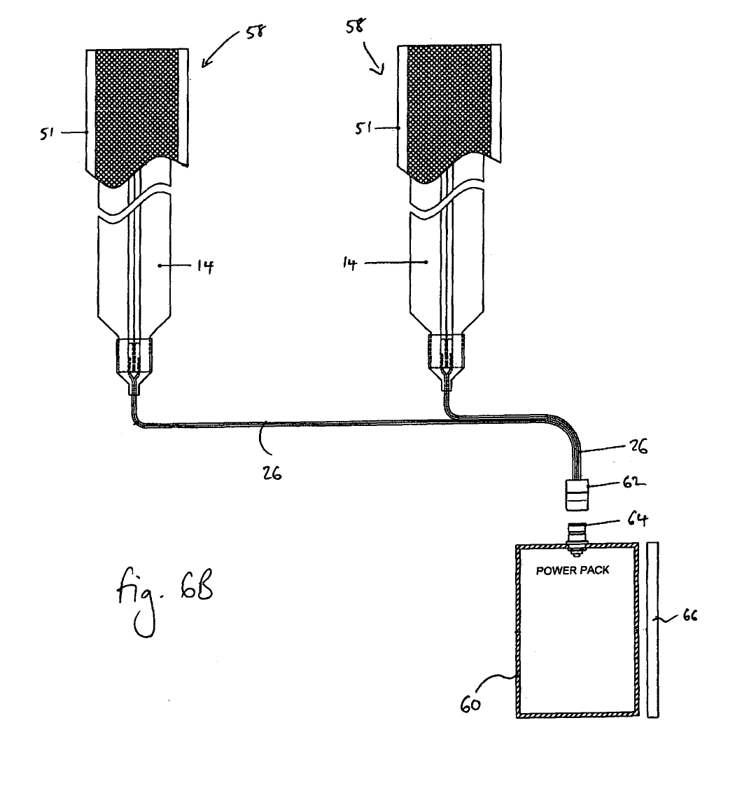

FIGS. 5A and 5B show schematic views of electroluminescent light assemblies 56, 58 which comprise an electroluminescent light source and the sheaths of FIGS. 4A and 4B respectively. In each case the front layer is cut away to permit the connected end of the electroluminescent light source to be seen. The process of assembly comprises inserting the electroluminescent light source into the pocket 50 of the sheath, followed by passing the electrical connection 26 through the slit to the hole, from where it protrudes. The slit and/or hole may be sealed after the electrical connection 26 is in place, e.g. using glue or a suitable covering patch. The assembly process may also include securing the backing and front layer together along join lines running parallel to their shorter edges. In FIG. 5A this is shown by weld lines 54. The advantage of sealing in this way is that water ingress is prevented. FIG. 5B shows the corresponding arrangement for the retroreflective front layer 52. FIGS. 5C and 5D show end views of the two assemblies, where the protruding electrical connection 26 can be seen.

In an alternative arrangement, the electroluminescent light source may be laminated on to the front layer of the sheath before that layer is attached to the backing layer to create the pocket. The backing layer may be part of the object to which the electroluminescent light assembly is to be attached. The front layer may be attached to the backing layer by stitching.

FIG. 6A is a schematic view of a pair of electroluminescent light assemblies 56 as shown in FIG. 5A connected to a power pack 60. FIG. 6B is corresponding schematic view of a pair of electroluminescent light assemblies 58 as shown in FIG. 5B connected to a power pack 60. The power pack may comprise an inverter (DC to AC current converter), e.g. powered by a rechargeable battery (e.g. a lithium ion battery or the like). The battery may be selected to provide an operating life (i.e. working life between recharges) of at least 8 hours. Preferably the power pack is sealed (e.g. permanently sealed) within a housing to prevent water and dust penetration. The housing may have a plug socket for charging the battery, but in a preferred embodiment recharging the battery is performed by an inductive coupling element. The housing may also have an output socket 64 for connecting to the electrical connection 26 via a suitable connector 62. The connector 62 may be detachable from the housing, e.g. so that the power pack may be provided as a stand alone item.

The power pack may have an activation switch to enable selection of an ON or OFF state. The switch may be magnetically activatable. In a preferred embodiment, a separate magnetic strip 66 may be used to activate the switch. The magnetic strip may be secured into the object to which the electroluminescent light source is applied, e.g. secured to the fabric of a battery pouch in a garment. In a development of this concept, the object may include a magnetic identification chip (e.g. RFID tag or similar) which is energised by the power pack. The power pack may thus recognise the type of object in use and configure itself accordingly.

To save power, the power pack may include an internal cut off mechanism arranged to trigger if the connection to the electroluminescent lamps is broken or if the load resistance on the battery exceeds a predetermined threshold.

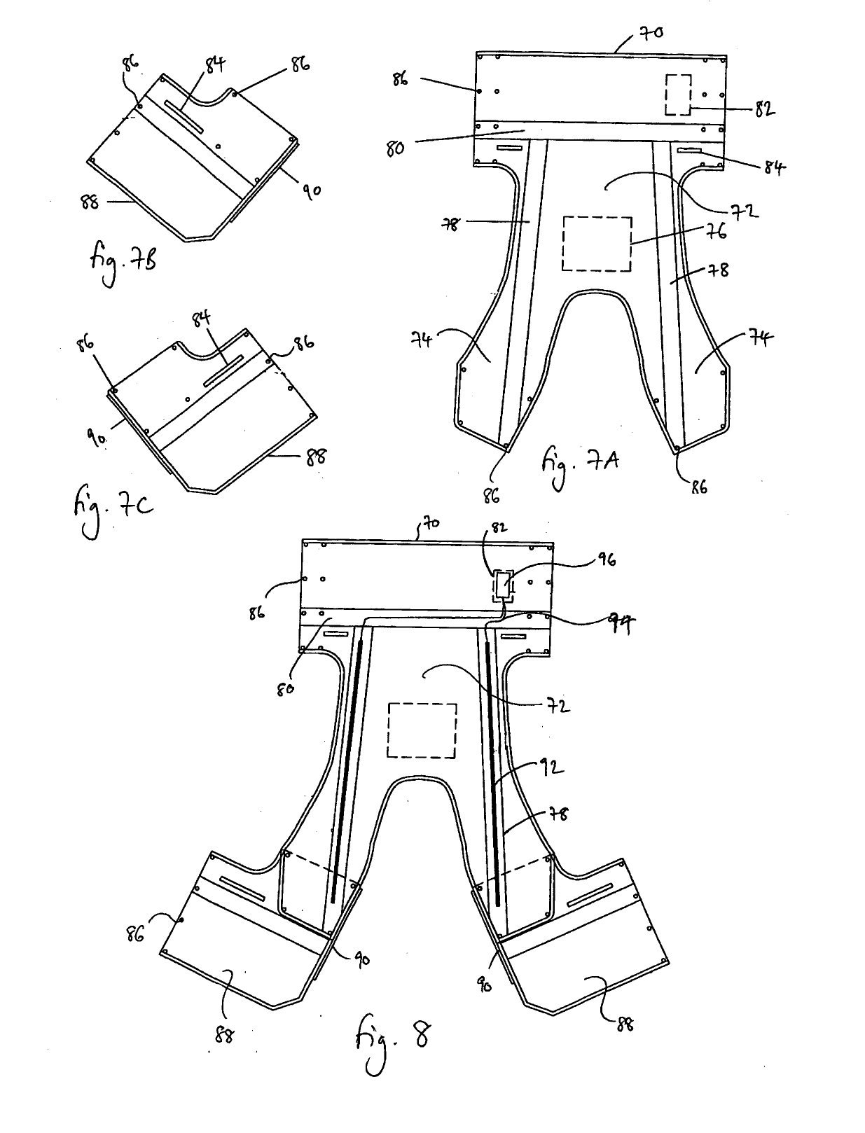

FIGS. 7A, 7B and 7C show the component parts of an anti-entanglement vest which is a first example of an object to which the present invention can be applied. FIG. 7A shows a body part 70 of the vest, which comprises a back panel 72 for overlying a user's back and two finger portions 74 for looping over a user's shoulder and extending down the front of the torso. The back panel 72 includes a removable logo patch 76, which can be attached by any conventional means (e.g. press poppers, stitching or hook and loop fastening, e.g. Velcro®).

Fabricated into the body part are two protective sheaths 78 that extend from a waist passage 80 to the ends of the finger portions 74. The protective sheaths 78 correspond to the sheaths discussed above with reference to FIGS. 4A and 4B.

The waist passage 80 is a tubular passage fabricated in the body part 70 to provide a pathway for carrying wires from the battery pouch 82 (which holds the power pack) to the protective sheaths 78.

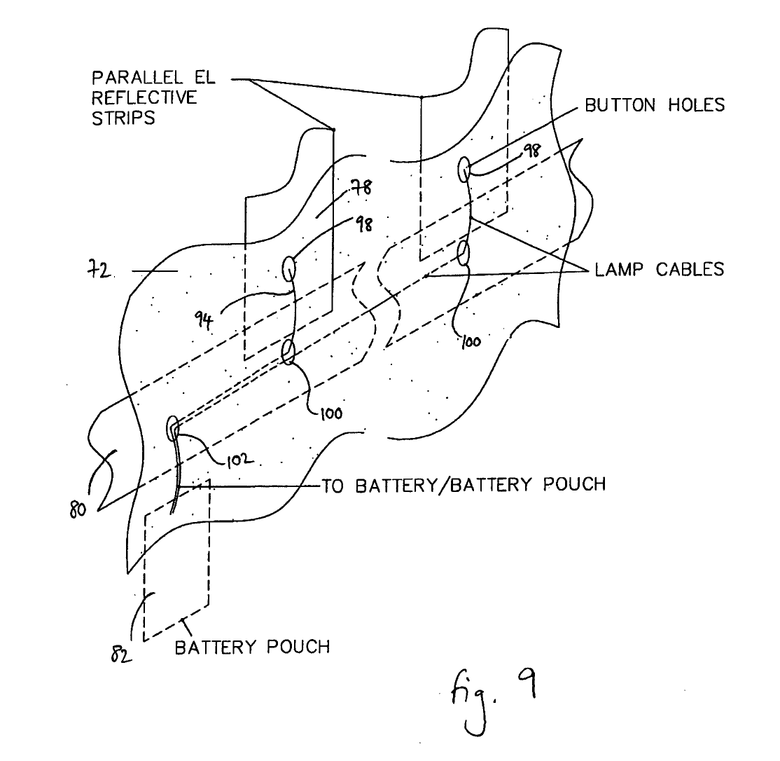

FIGS. 7B and 7C show wing parts 88 of the vest. The wing parts are attachable to body part 70 by a detachable coupling 86. In this example, the detachable coupling is a plurality of press poppers, but a hook and loop fastening (e.g.)Velcro® may also be used. The wing parts attach to the body part both at the end of the finger portions 74 (see FIG. 8) and at the sides of the back panel 72. The purpose of the detachable coupling is to facilitate rapid removal of the vest if it becomes, trapped in moving machinery. This may be advantageous if the vest needs to comply with standards for protective clothing where there is a risk of entanglement with moving parts (e.g. EN510:1993).

Elastic strips 84 are provided on both the body part 70 and the wing parts 88 to provide some “give” to the vest such that the detachable coupling'does not accidentally become detached.

The wing parts 88 are attachable to each other (e.g. across the front of the user) via a suitable closure 90. In this example, the closure is a zip fastening, but press poppers or a hook and loop fastening (e.g.)Velcro® may also be used.

FIG. 8 shows the component parts of FIGS. 7A, 7B and 7C in an, assembled form with an electroluminescent light source 92 in place in each of the sheaths 78. The electrical connections 94 from each electroluminescent light source 92 travel through the waist passage 80 to the power pack 96 in the battery pouch 82. This is shown in more detail in FIG. 9. The electrical connections 94 (lamp cables) pass out of the sheaths 78 via button holes 98 and enter the waist passage 80 via button holes 100, which are position on the waist passage in locations aligned with the sheath's 78. The electrical connections 94 exit the waist passage 80 at button hole 102, which is aligned with battery pouch 82. This arrangement minimised the length of exposed wiring. The wires may also be held away from stitched regions of the garment, which may prevent damage.

To complete assembly such that the vest is ready to wear, the press poppers 86 on the wing parts 88 need to be attached to corresponding press poppers 86 on the sides of the back panel 72. FIGS. 10A and 10B shown the front and back views of the vest when fully assembled with the zip fastening 90 closed. Here it can be seen that the protective sheaths 78 are formed on the body part 70 in a configuration that yields parallel lines on the back of the vest and a V-shaped formation on the front.

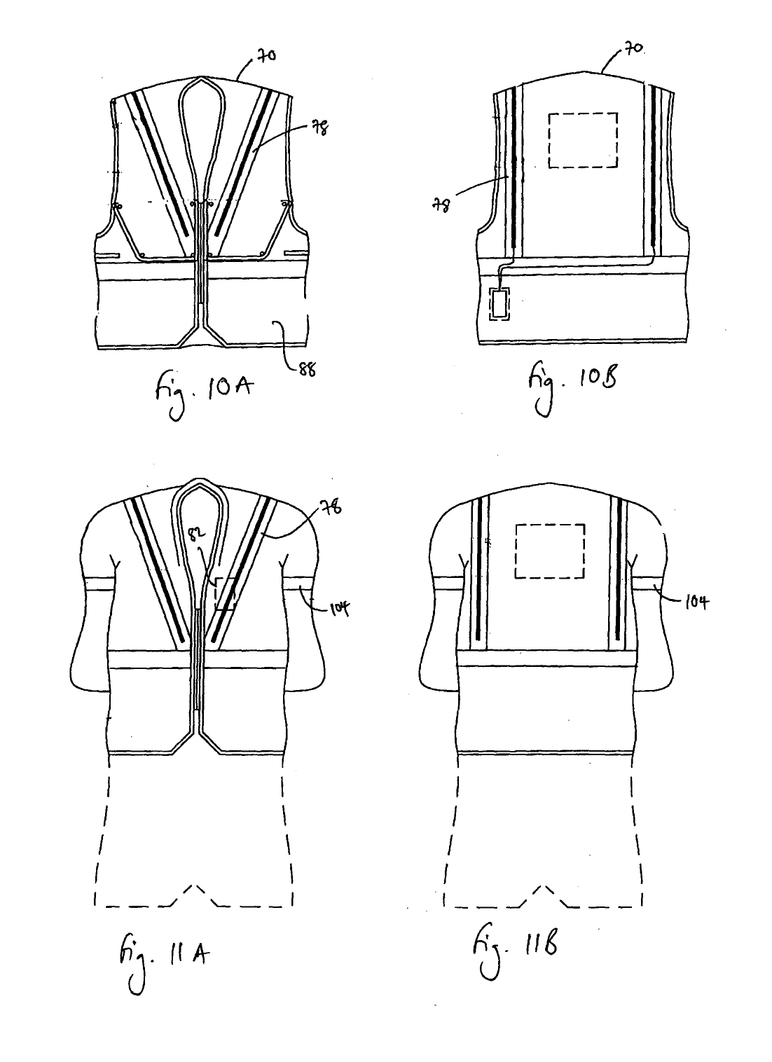

FIGS. 11A and 11B show front and back views of another example of a garment that incorporates the electroluminescent light assemblies of the invention. In this case the garment is a jacket, or boiler suit (indicated by dotted lines). This example does not have the anti-entanglement features (i.e. the detachable couplings) of the vest shown in FIGS. 8 to 10. However, the configuration of the protective sheaths 78 and their corresponding electroluminescent light sources 92 is the same. In this example the battery pouch 82 is provided as an internal breast pocket. Further electroluminescent light sources may be provided in strips 104 formed around the arms of this garment.

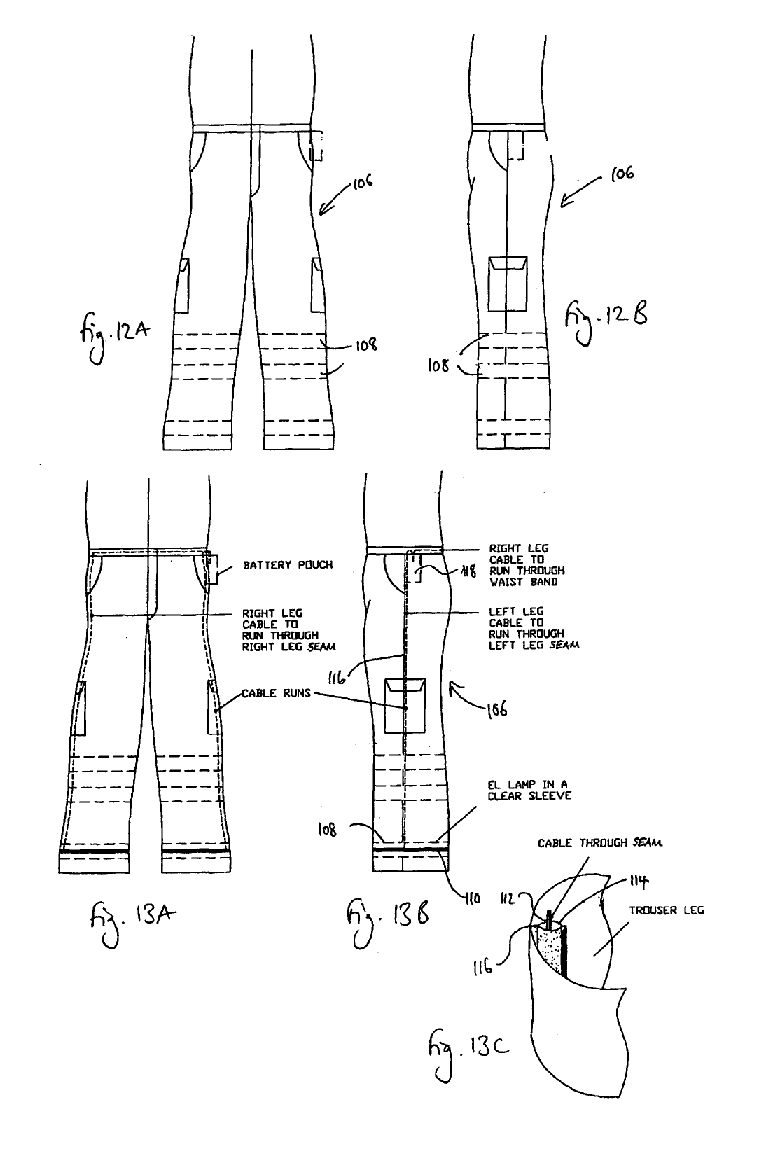

FIGS. 12A and 12B show front and side views of another example of a garment that incorporates the electroluminescent light assemblies of the invention. In this case the garment is a pair of trousers 106 (or the trousers of a boiler suit). A plurality of protective sheaths 108 are formed around the base of each leg of the trousers 106.

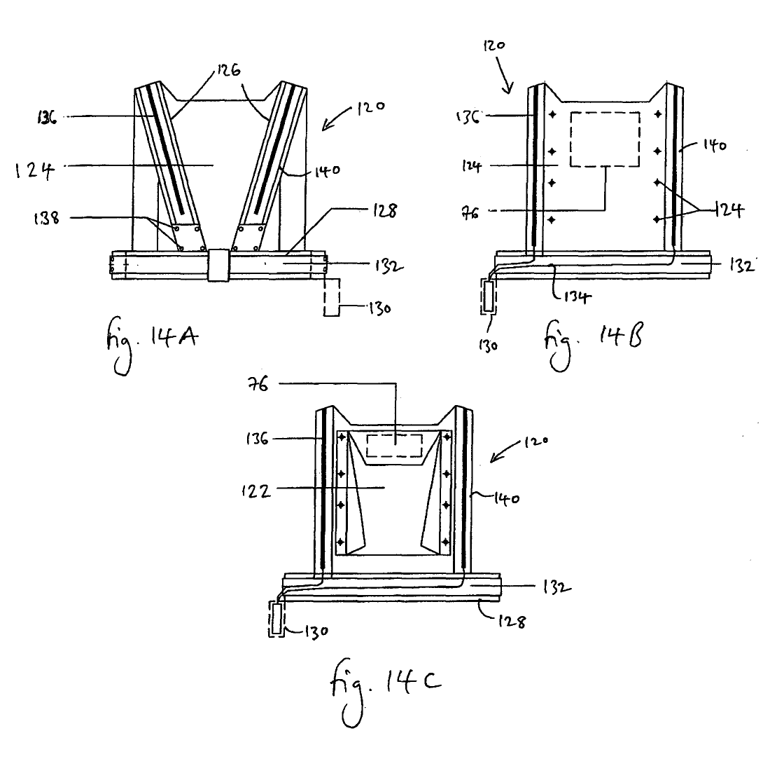

FIGS. 13A, 13B and 13C show the how the electroluminescent light sources 110 are secured to the trousers 106 shown in FIG. 12. The electrical connection 112 in this embodiment passes through a tubular passage 114 formed at (and attached too) the seam 116 that runs down the side of each trouser leg. The battery pouch 118 in this case is attached to the waist on one side of the trousers 106. The wiring from the trouser leg on the opposite side from the battery pouch travels through a passage in the waistband. The electroluminescent light sources 110 may have a length to provide a light glow extending for at least 270° around the feet area.

FIGS. 14A, 14B and 14C show front and back views of another example of an object that incorporates the electroluminescent light assemblies of the invention. In this case the object is a harness 120 for a backpack: The backpack 122 itself is shown attached to the harness 120 in FIG. 14C. In this example it is attached via a detachable coupling 124 (e.g. quick release buckle or press poppers), but it may also be permanently connected to or integrally formed with the harness 120. The backpack 122 and/or the harness 120 may have a logo patch 76.

The harness 120 has a back panel 124, a pair of shoulders straps 126 and a waist belt 128. The shoulders straps 126 may be secured to the waist belt 128 by a suitable fastening 138(e.g. quick release buckle or press poppers). The battery pouch 130 may hang from the waist belt 128. The waist belt 128 may have an internal passage 132 for carrying the electrical connections 134 of the electroluminescent light sources 136.

In this embodiment the protective sheaths 140 for the electroluminescent light sources 136 are formed along the shoulder straps 136 (which lie in a V-shaped formation when worn) and in parallel down the sides of the back panel 124.

1. An electroluminescent light assembly for an object, the assembly comprising:
an electroluminescent light source comprising an elongate electroluminescent lamp laminated on a reflective base material;
a protective sheath defining an elongate pocket for receiving the electroluminescent light source, the protective sheath having a transparent outward facing surface;
wherein the width of the reflective base material matches the width of the pocket to align the elongate electroluminescent lamp with the protective sheath.

2. An electroluminescent light assembly according to claim 1 further comprising a power supply, wherein the elongate electroluminescent lamp includes a power connection point that is connected to the power supply via a power cable, and wherein the protective sheath comprises an aperture for receiving the power cable.

3. An electroluminescent light assembly according to claim 2, wherein the power connection point is sealed by shrink wrap.

4. An electroluminescent light assembly according to claim 1, wherein one or both ends of the elongate electroluminescent lamp is sealed by shrink wrap.

5. An electroluminescent light assembly according to claim 1, wherein the protective sheath comprises an elongate strip of transparent material secured to a backing layer along join lines which run parallel to each long edge of the elongate strip, the pocket being the internal space between the join lines.

6. An electroluminescent light assembly according to claim 5, wherein the electroluminescent light source is laminated on to the elongate strip of transparent material.

7. An electroluminescent light assembly according to claim 5, wherein the transparent material is retroreflective.

8. An electroluminescent light assembly according to claim 5, wherein the backing layer is part of the object on which the assembly is to be formed.

9. An anti-entanglement vest comprising:
a body part comprising a back panel and a pair of shoulder elements;
a pair of wing parts detachably couplable to the back panel and shoulder elements, the wing parts being couplable to one another; and
an electroluminescent light assembly comprising:
a pair of electroluminescent light sources, each electroluminescent light source comprising an elongate electroluminescent lamp laminated on a reflective base material;
a pair of protective sheaths on the body part, each sheath extending from a waist band of the body part along a respective shoulder element, defining an elongate pocket for receiving a respective electroluminescent light source, and having a transparent outward facing surface; and
a power supply held in a pouch formed in the body part;
wherein:
the width of the reflective base material matches the width of the pocket to align the elongate electroluminescent lamp with the protective sheath;
each elongate electroluminescent lamp includes a power connection point that is connected to the power supply via a respective power cable, each protective sheath comprising an aperture for receiving the power cable; and
the body part include a passageway formed along the waist band thereof for carrying the power cables between the protective sheaths and the pouch.

10. A pair of trousers having an electroluminescent light assembly comprising:
a pair of electroluminescent light sources, each electroluminescent light source comprising an elongate electroluminescent lamp laminated on a reflective base material;
a pair of protective sheaths, each sheath formed around the respective leg the pair of trousers, defining an elongate pocket for receiving a respective electroluminescent light source, and having a transparent outward facing surface; and
a power supply held in a pouch attached to the waist band of the trousers;
wherein:
the width of the reflective base material matches the width of the pocket to align the elongate electroluminescent lamp with the protective sheath;
each elongate electroluminescent lamp includes a power connection point that is connected to the power supply via a respective power cable, each protective sheath comprising an aperture for receiving the power cable; and
the pair of trousers includes a passageway formed along the seam of each leg and around the waist band thereof for carrying the power cables between the protective sheaths and the pouch.

11. A method of applying an electroluminescent light assembly to an object, the method comprising:
laminating an elongate electroluminescent lamp on to a reflective base material to form an electroluminescent light source;
securing a protective sheath on the object, the protective sheath defining an elongate pocket for receiving the electroluminescent light source, the protective sheath having a transparent outward facing surface;
matching the width of the reflective base material to the width of the pocket; and
inserting the electroluminescent light source into the protective sheath.

12. A method according to claim 11 including connecting a power connection point on the elongate electroluminescent lamp to a power supply using a power cable, wherein inserting the electroluminescent light source into the protective sheath including passing the power cable through an aperture formed in the protective sheath.

13. A method according to claim 12 including shrink wrapping the power connection point on the elongate electroluminescent lamp after it is connected to the power cable.

14. A method according to claim 12 wherein the protective sheath comprises an elongate strip of transparent material secured to a backing layer along join lines which run parallel to each long edge of the elongate strip, the pocket being the internal space between the join line, and wherein inserting the electroluminescent light source into the protective sheath comprises laminating the electroluminescent light source on to the elongate strip of transparent material before it is secured to the backing layer.
